(19) United States
(12) Patent Application Publication
(10) Pub. No.: US 2010/0169178 A1
(43) Pub. Date: Jul. 1, 2010

(54) Advertising Method for Image Search

(75) Inventors: Xin-Jing Wang, Beijing (CN); Lei Zhang, Beijing (CN); Wei-Ying Ma, Beijing (CN)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/344,295

(22) Filed: Dec. 26, 2008

(51) Int. Cl. G06Q 30/00; G06F 17/30

(52) U.S. Cl. 705/14.54; 707/E17.019; 707/E17.108

(57) ABSTRACT

A method for advertising in response to an image search. One or more keywords may be received. The keywords may be for searching one or more images on the network. The images may be retrieved based on the keywords. One or more advertisements may be selected based on a first visual content of the images and a second visual content of the one or more advertisements. The one or more of the advertisements may be displayed.

### BACKGROUND

Many search engine services search for information that is accessible via the Internet. These search engine services allow users to search for display pages, such as web pages, that may be of interest to users. After a user submits a search request (also referred to as a “query”) that includes search terms, the search engine service identifies web pages that may be related to those search terms. To quickly identify related web pages, the search engine services may maintain a mapping of keywords to web pages. This mapping may be generated by “crawling” the web (i.e., the World Wide Web) to identify the keywords of each web page. To crawl the web, a search engine service may use a list of base web pages to identify all web pages that are accessible through those base web pages. The keywords of any particular web page can be identified using various well-known information retrieval techniques, such as identifying the words of a headline, the words supplied in the metadata of the web page, the words that are highlighted, and so on. The search engine service may generate a relevance score to indicate how related the information of the web page may be to the search request. The search engine service then displays to the user links to those web pages in an order that is based on their relevance.

Several search engine services also provide for searching for images that are available on the Internet. These image search engines typically generate a mapping of keywords to images by crawling the web in much the same way as described above for mapping keywords to web pages. An image search engine service can identify keywords based on text of the web pages that contain the images. An image search engine may also gather keywords from metadata associated with images of web-based image forums, which are an increasingly popular mechanism for people to publish their photographs and other images. An image forum allows users to upload their photographs and requires the users to provide associated metadata such as title, camera setting, category, and description. The image forums typically allow reviewers to rate each of the uploaded images and thus have ratings on the quality of the images. Regardless of how the mappings are generated, an image search engine service inputs an image query and uses the mapping to find images that are related to the image query. An image search engine service may identify thousands of images that are related to an image query and presents thumbnails of the related images. To help a user view the images, an image search engine service may order the thumbnails based on relevance of the images to the image query. An image search engine service may also limit the number of images that are provided to a few hundred of the most relevant images so as not to overwhelm the viewer.

### SUMMARY

Described herein are implementations of various technologies for an advertising method in response to an image search. In one implementation, a user provides search keywords for an image search. A network, such as, the Internet, may be searched for images based on the keywords. The keywords may be matched against, titles, captions, or other descriptive text associated with the images. The images that match the search keywords may be retrieved. The images may be grouped into categories based upon phrases contained within the images' descriptive text. Each category may be described by a keyword phrase. The keyword phrase may have a meaning that is common within the descriptive text of all images in the category.

The keyword phrases of the categories may be matched against titles, captions or other descriptive text associated with a database of advertisements. Accordingly, a set of advertisements may be selected for each category based on the keyword phrases.

The advertisements database may also contain codes for each advertisement that describe the visual content of the advertisements. Similarly, codes may be generated that describe the visual content of the retrieved images. The codes that are generated for the images may be used to rank the advertisements selected for each category. In other words, the advertisements with visual content that are more similar to the images in a particular category may be ranked higher than the advertisements with visual content that are less similar to the images in the category.

A representative image from each category may be selected and displayed on a user interface. The user may select the category of images to be displayed by clicking on the category's representative image. The images within the category may be displayed along with the highest ranked advertisements for the selected category.

In one implementation, the advertisements may be video advertisements. In such an implementation, the audio may be muted when the advertisements are first displayed. The user may enable the audio by mousing over the advertisement that the user wishes to hear.

The claimed subject matter is not limited to implementations that solve any or all of the noted disadvantages. Further, the summary section is provided to introduce a selection of concepts in a simplified form that are further described below in the detailed description section. The summary section is not intended to identify key features or essential features of the claimed subject matter, nor is it intended to be used to limit the scope of the claimed subject matter.

### BRIEF DESCRIPTION OF THE DRAWINGS

FIG. 1 illustrates a schematic diagram of a computing system in which various technologies described herein may be incorporated and practiced.

FIG. 2 illustrates a flow chart of an advertising method for image search in accordance with implementations of various technologies described herein.

FIG. 3 illustrates a flow chart of a step for grouping images into categories in accordance with implementations of various technologies described herein.

FIG. 4 illustrates a user interface in accordance with implementations of various technologies described herein.

### DETAILED DESCRIPTION

As to terminology, any of the functions described with reference to the figures can be implemented using software, firmware, hardware (e.g., fixed logic circuitry), manual processing, or a combination of these implementations. The term “logic, “module,” “component,” or “functionality” as used herein generally represents software, firmware, hardware, or a combination of these implementations. For instance, in the case of a software implementation, the term “logic,” “module,” “component,” or “functionality” represents program code (or declarative content) that is configured to perform specified tasks when executed on a processing device or devices (e.g., CPU or CPUs). The program code can be stored in one or more computer readable media.

More generally, the illustrated separation of logic, modules, components and functionality into distinct units may reflect an actual physical grouping and allocation of such software, firmware, and/or hardware, or may correspond to a conceptual allocation of different tasks performed by a single software program, firmware program, and/or hardware unit. The illustrated logic, modules, components, and functionality can be located at a single site (e.g., as implemented by a processing device), or can be distributed over plural locations.

The terms “machine-readable media” or the like refers to any kind of medium for retaining information in any form, including various kinds of storage devices (magnetic, optical, solid state, etc.). The term machine-readable media also encompasses transitory forms of representing information, including various hardwired and/or wireless links for transmitting the information from one point to another.

The techniques described herein are also described in various flowcharts. To facilitate discussion, certain operations are described in these flowcharts as constituting distinct steps performed in a certain order. Such implementations are exemplary and non-limiting. Certain operations can be grouped together and performed in a single operation, and certain operations can be performed in an order that differs from the order employed in the examples set forth in this disclosure.

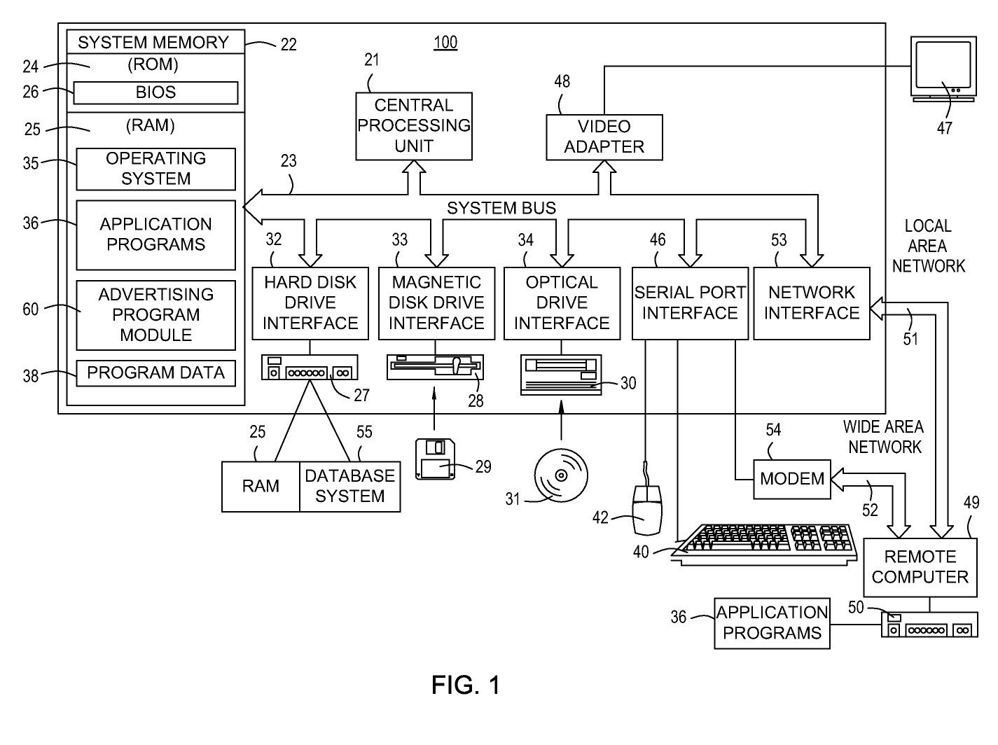

FIG. 1 illustrates a schematic diagram of a computing system 100 in which the various technologies described herein may be incorporated and practiced. Although the computing system 100 may be a conventional desktop or a server computer, as described above, other computer system configurations may be used.

The computing system 100 may include a central processing unit (CPU) 21, a system memory 22 and a system bus 23 that couples various system components including the system memory 22 to the CPU 21. Although only one CPU is illustrated in FIG. 1, it should be understood that in some implementations the computing system 100 may include more than one CPU. The system bus 23 may be any of several types of bus structures, including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. The system memory 22 may include a read only memory (ROM) 24 and a random access memory (RAM) 25. A basic input/output system (BIOS) 26, containing the basic routines that help transfer information between elements within the computing system 100, such as during start-up, may be stored in the ROM 24.

The computing system 100 may further include a hard disk drive 27 for reading from and writing to a hard disk, a magnetic disk drive 28 for reading from and writing to a removable magnetic disk 29, and an optical disk drive 30 for reading from and writing to a removable optical disk 31, such as a CD ROM or other optical media. The hard disk drive 27, the magnetic disk drive 28, and the optical disk drive 30 may be connected to the system bus 23 by a hard disk drive interface 32, a magnetic disk drive interface 33, and an optical drive interface 34, respectively. The drives and their associated computer-readable media may provide nonvolatile storage of computer-readable instructions, data structures, program modules and other data for the computing system 100.

Although the computing system 100 is described herein as having a hard disk, a removable magnetic disk 29 and a removable optical disk 31, it should be appreciated by those skilled in the art that the computing system 100 may also include other types of computer-readable media that may be accessed by a computer. For example, such computer-readable media may include computer storage media and communication media. Computer storage media may include volatile and non-volatile, and removable and non-removable media implemented in any method or technology for storage of information, such as computer-readable instructions, data structures, program modules or other data. Computer storage media may further include RAM, ROM, erasable programmable read-only memory (EPROM), electrically erasable programmable read-only memory (EEPROM), flash memory or other solid state memory technology, CD-ROM, digital versatile disks (DVD), or other optical storage, magnetic cassettes, magnetic tape, magnetic disk storage or other magnetic storage devices, or any other medium which can be used to store the desired information and which can be accessed by the computing system 100. Communication media may embody computer readable instructions, data structures, program modules or other data in a modulated data signal, such as a carrier wave or other transport mechanism and may include any information delivery media. The term “modulated data signal” may mean a signal that has one or more of its characteristics set or changed in such a manner as to encode information in the signal. By way of example, and not limitation, communication media may include wired media such as a wired network or direct-wired connection, and wireless media such as acoustic, RF, infrared and other wireless media. Combinations of the any of the above may also be included within the scope of computer readable media.

A number of program modules may be stored on the hard disk, magnetic disk 29, optical disk 31, ROM 24 or RAM 25, including an operating system 35, application programs 36, an advertising program module 60, program data 38 and a database system 55. The operating system 35 may be any suitable operating system that may control the operation of a networked personal or server computer, such as Windows® XP, Mac OS® X, Unix-variants (e.g., Linux® and BSD®), and the like.

A user may enter commands and information into the computing system 100 through input devices such as a keyboard 40 and pointing device 42. Other input devices may include a microphone, joystick, game pad, satellite dish, scanner, or the like. These and other input devices may be connected to the CPU 21 through a serial port interface 46 coupled to system bus 23, but may be connected by other interfaces, such as a parallel port, game port or a universal serial bus (USB). A monitor 47 or other type of display device may also be connected to system bus 23 via an interface, such as a video adapter 48. In addition to the monitor 47, the computing system 100 may further include other peripheral output devices, such as speakers and printers.

Further, the computing system 100 may operate in a networked environment using logical connections to one or more remote computers, such as a remote computer 49. The remote computer 49 may be another personal computer, a server, a router, a network PC, a peer device or other common network node. Although the remote computer 49 is illustrated as having only a memory storage device 50, the remote computer 49 may include many or all of the elements described above relative to the computing system 100. The logical connections may be any connection that is commonplace in offices, enterprise-wide computer networks, intranets, and the Internet, such as local area network (LAN) 51 and a wide area network (WAN) 52.

When using a LAN networking environment, the computing system 100 may be connected to the local network 51 through a network interface or adapter 53. When used in a WAN networking environment, the computing system 100 may include a modem 54, wireless router or other means for establishing communication over a wide area network 52, such as the Internet. The modem 54, which may be internal or external, may be connected to the system bus 23 via the serial port interface 46. In a networked environment, program modules depicted relative to the computing system 100, or portions thereof, may be stored in a remote memory storage device 50. It will be appreciated that the network connections shown are exemplary and other means of establishing a communications link between the computers may be used.

The advertising program module 60 may select and display relevant advertisements alongside images that are found on the network with an image search. In one implementation, the advertising program module 60 may receive keywords for searching for one or more images on the network. The keywords may be received from a user of the computing system 100.

The advertising program module 60 may retrieve images from the network based on the keywords. The advertising program module 60 may select one or more advertisements based on the keywords as well. The selected advertisements may then be displayed on the monitor 47 at the same time as the images retrieved in the image search. In one implementation, thumbnails of the retrieved images may be displayed instead of the actual images.

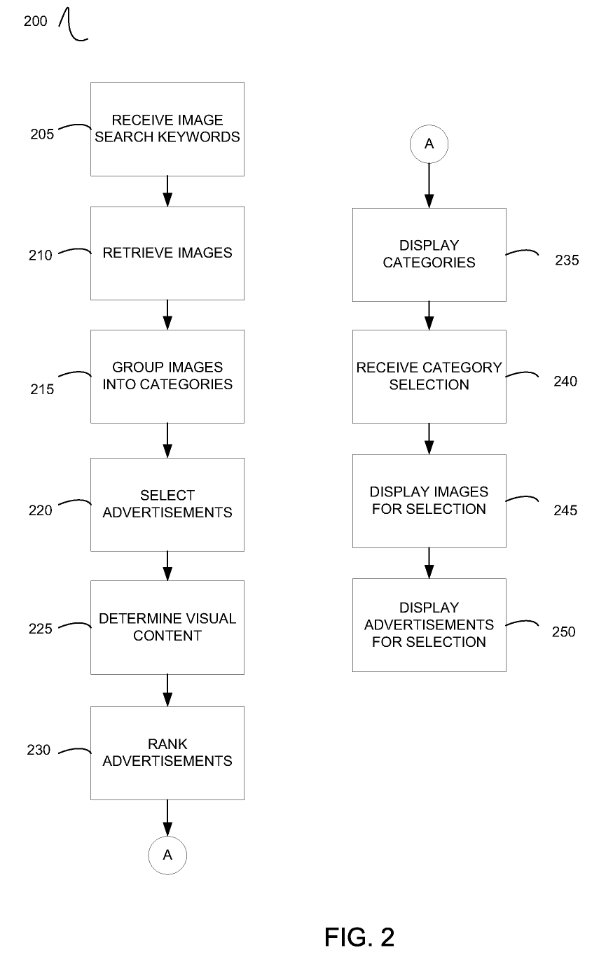

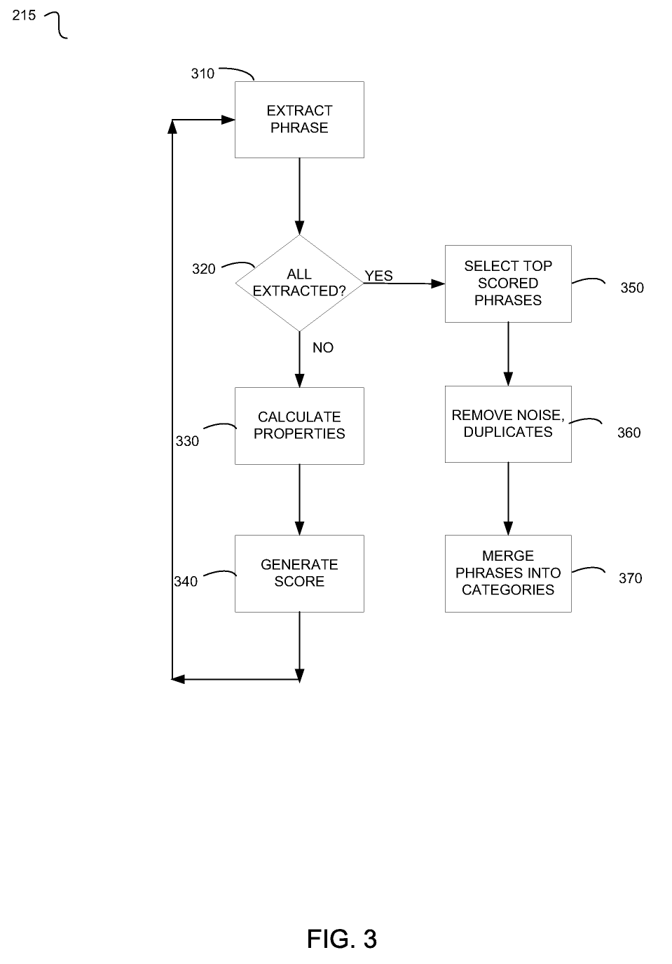

The advertisements may be stored in a database that is managed by the database system 55. Alternately, the advertisements may be contained in the program data 38. In one implementation, the advertisements may be video advertisements. The advertising program module 60 will be described in more detail with reference to FIGS. 2-3 in the paragraphs below.

It should be understood that the various technologies described herein may be implemented in connection with hardware, software or a combination of both. Thus, various technologies, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computer, the machine becomes an apparatus for practicing the various technologies. In the case of program code execution on programmable computers, the computing device may include a processor, a storage medium readable by the processor (including volatile and non-volatile memory and/or storage elements), at least one input device, and at least one output device. One or more programs that may implement or utilize the various technologies described herein may use an application programming interface (API), reusable controls, and the like. Such programs may be implemented in a high level procedural or object oriented programming language to communicate with a computer system. However, the program(s) may be implemented in assembly or machine language, if desired. In any case, the language may be a compiled or interpreted language, and combined with hardware implementations.

FIG. 2 illustrates a flow chart of an advertising method 200 for an image search in accordance with implementations of various technologies described herein. The method 200 may be performed by the advertising program module 60. It should be understood that while the operational flow diagram of the method 200 indicates a particular order of execution of the operations, in some implementations, the operations might be executed in a different order.

At step 205, the advertising program module 60 may receive keywords for performing an image search on the network. In one implementation, the network may be the Internet. At step 210, the advertising program module 60 may retrieve images from the network based on the keywords. In one implementation, the images may be stored on the network with titles, captions, or other descriptions. In such an implementation, the advertising program module may retrieve images with descriptions that contain the search keywords.

Generally, these images are very diverse, visually and semantically. For example, when searching for “cat” images, the images returned may include cats, cat furniture, cat toys, etc. As such, at step 215, the images may be grouped into semantic categories. Each category may be described with a particular phrase that is common to all the images within the category. In the above scenario, semantic categories may include “cats,” “toys,” and “pet furniture.”

Each category then may contain a subset of the search results. For example, images of cats are in the cats category, images of cat toys in the toys category, etc. The step 215 for grouping the images into categories will be described in more detail with reference to the description for FIG. 3.

At step 220, the advertisements may be selected based on the categories. In one implementation, each advertisement may be stored with a set of textual phrases. The phrases may include titles and descriptions of the advertisements. Accordingly, for each category, a set of advertisements may be selected where the phrase that describes the category matches the phrases stored with the advertisements.

In one implementation, the phrases associated with the advertisements may include specific search keywords. For example, an advertiser of barber shops may want to have their ad displayed in response to image searches with keywords, such as “hair cut,” “salon,” and “barber shop.” As such, a barber shop ad may be stored with these keywords in the advertisement database. In such an implementation, advertisements may be selected where the search keywords match the specified keywords associated with the advertisements.

In addition to a textual search, the advertising program module 60 may conduct a content-based search for advertisements. In a content-based search, the rich information embedded in visual content may be used to select advertisements that are visually similar to the images in the search results. The visual content may include many features of images, advertisements that provide a statistical evaluation of the global appearance of an image. These features may include color, texture, shape, etc, or local patterns such as evenly-divided grids, scale-invariant salient regions, etc. By combining a textual search with a content-based search, advertisements may be selected that are both semantically and visually similar to the images in the search results. In one implementation, the content-based search may be conducted as an alternative to the textual search for advertisements.

For the content-based search, a representative image may be selected for each category. The representative image may be used to conduct the content-based search. Typically, content-based searches may become a bottleneck in the efficiency of adverting for image searches. Accordingly, the content-based search may use encoding techniques. At step 225, the visual content of the representative images may be determined. In one implementation, the visual content may be determined by encoding the representative images into hash codes using a hash mapping method, e.g. Locality-Sensitive Hashing, decision tree, or vector quantization.

For example, to encode images into hash codes, the image may be partitioned into even blocks. A multi-dimensional feature vector may then be constructed to describe the visual content of the image. Each feature of this vector may be an average luminance of each block.

The feature vector may be transformed by a PCA (Principle Component Analysis) mapping matrix learned beforehand, and then quantized into hash codes. In one implementation, the quantization strategy may be to quantize features to 1 if the average luminance is larger than the mean of the feature vector. Otherwise, the feature may be quantized to 0. In one implementation, a color correlogram may be used instead of the average luminance.

Similar to the textual phrases stored with the advertisements, hash codes that represent the visual content of the advertisements may be stored with the advertisements. In the case of a video advertisement, multiple hash codes may be stored with the advertisements. The hash codes may be generated by encoding key images within the video advertisement. For example, two or three images may be selected as the key images within the video advertisement. The key images may be based on the images within the ad that best represent the visual content of the video ad.

At step 230, the advertisements selected for each category may be ranked. The ranking may be based on the visual content of the representative images and the visual content of the advertisements. The ads that are most visually similar to the representative images for each category may be ranked highest for that category.

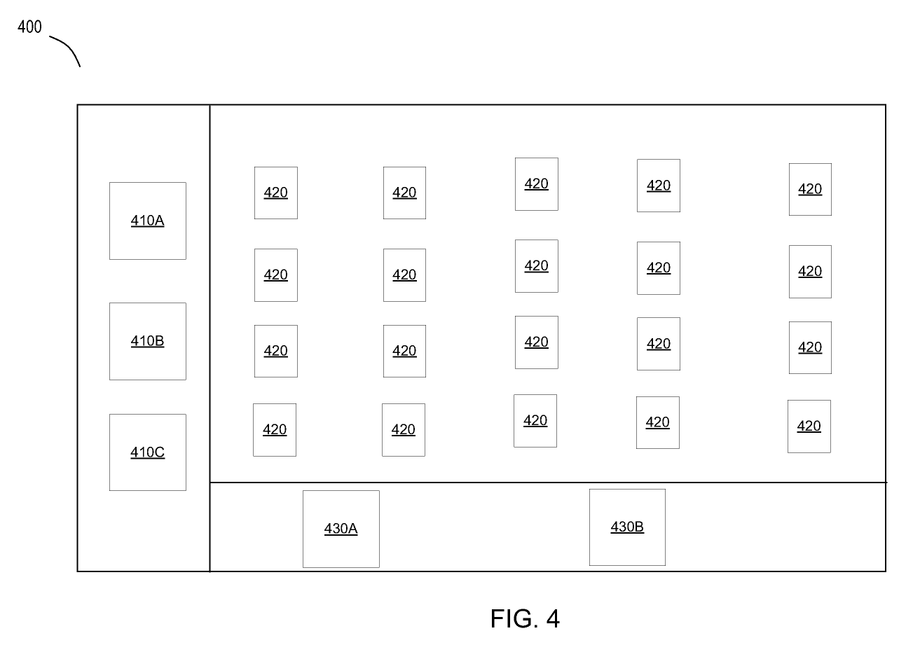

Steps 235-250 will be described with reference to FIG. 4, which illustrates a user interface (UI) 400 in accordance with implementations of various technologies described herein. At step 235, the categories may be displayed on the UI 400. As shown, the representative images for each category may be displayed as category images 410A, 410B, and 410C.

At step 240, a category selection may be received. The user may then select the images in the search results that the viewer would like to view by selecting one of the categories. In one implementation, the user may click on one of the category images 410A, 410B, and 410C that represents a category of interest to the user.

At step 245, the images for the selected category may be displayed. In one implementation, the images belonging to the selected category may be displayed as thumbnails 420, as shown.

At step 250, the advertisements for the selected category may be displayed. The highest ranked advertisements for the selected category may be displayed in the advertising windows 430A, 430B. It should be noted that the number of advertisements shown in the UI 400 may vary.

In an implementation where video advertisements are displayed, the audio accompanying the video may be muted. Advantageously, by muting the audio, the user may select an ad for viewing without being confused by overlapping audios. In one implementation, the user may mouse over the advertisement to select the advertisement for viewing. In response, the audio for the accompanying video ad may be played.

In another implementation, the advertisements may be displayed in place of one of the thumbnails 420. In such an implementation, the user may mouse over a thumbnail image. In response, the thumbnail image may be enlarged to the actual size of the original image. The video advertisement may then be displayed in place of the enlarged image. At the conclusion of the advertisement, the original image may be displayed.

FIG. 3 illustrates a flow chart of the step 215 for grouping images into categories in accordance with implementations of various technologies described herein. The categories may be based on the descriptions associated with the retrieved images in the search results. Each of the descriptions for the search results may contain a number of phrases. The phrases may be evaluated as described below to determine the semantic categories. Steps 310-340 may be repeated for every phrase in all the descriptions.

At step 310, one phrase may be extracted from the descriptions. At step 320, if all the phrases have been extracted, then the flow proceeds to step 350. If all the phrases have not been extracted, the flow proceeds to step 330.

At step 330, properties for the extracted phrase may be calculated. In one implementation, the properties may include a frequency with which the phrase is repeated within all the descriptions.

At step 340, a score may be generated for the extracted phrase. The score may be based on the calculated properties using, for example, a linear regression model. The flow then proceeds to step 310 to extract the next phrase.

At step 350, the top scoring phrases may be selected from all the phrases in the descriptions. The number of phrases selected may vary according to specific implementations. In one implementation, top 10 scoring phrases may be selected.

At step 360, phrases that represent noise, or duplicates, may be removed from the top phrases. Noise may include common words that add no meaning to a grouping, such as, “a,” “an,” and “the.” In some cases, phrases may be duplicated within other phrases. In such a case, the duplicates may be removed.

At step 370, the phrases may be merged into categories. As stated previously, the categories may be used for organizing the images. Each image associated with all the phrases merged into a category may be included in that category. The phrases may be merged where similarities exist. Similarities may include, for example, different phrases with similar meanings, or different phrases that include words with similar meanings.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method for advertising in response to an image search, comprising:
receiving one or more keywords for searching one or more images on the network;
retrieving the images based on the keywords;
selecting one or more advertisements based on a first visual content of the images and a second visual content of the one or more advertisements; and
displaying the one or more of the advertisements.

2. The method of claim 1, further comprising ranking the one or more advertisements based on the first visual content and the second visual content, and wherein the one or more advertisements are displayed based on the ranking.

3. The method of claim 1, wherein the first visual content is based on an image hashcode for each of the images and the second visual content is based on an ad hashcode for each advertisement.

4. The method of claim 1, further comprising grouping the images into one or more categories based on one or more descriptions associated with the images, wherein the one or more advertisements are selected based on the one or more categories.

5. The method of claim 4, further comprising:
displaying the categories;
receiving a selection of one of the categories; and
displaying the one or more of the advertisements based on the selection.

6. The method of claim 5, wherein displaying the categories comprises displaying one of the images to represent one of the categories.

7. The method of claim 4, further comprising:
displaying the categories;
receiving a selection of one of the categories; and
displaying the images grouped into the selected category.

8. The method of claim 1, further comprising:
receiving a selection of one of the advertisements; and
playing an audio file associated with the selected one of the advertisements.

9. The method of claim 8, wherein the selection of the one of the advertisements is performed using a mouse over action.

10. The method of claim 1, wherein the advertisements are displayed without any sound.

11. The method of claim 1, wherein the network is the Internet.

12. The method of claim 1, wherein the advertisements are video advertisements.

13. A user interface for displaying video advertisements, comprising:
displaying one or more representative images for one or more categories of one or more images;
receiving a selection of one of the representative images;
selecting one or more video advertisements based on the selection; and
displaying the video advertisements based on the selection.

14. The user interface of claim 13, further comprising:
selecting a subset of the images based on the selection; and
displaying the subset of images.

15. The user interface of claim 13, further comprising:
receiving a selection of one of the video advertisements; and
playing an audio file associated with the selected video advertisement.

16. The user interface of claim 13, wherein the video advertisements are displayed without any sound.

17. The user interface of claim 16, further comprising:
receiving a selection of one of the video advertisements; and
playing an audio file associated with the selected video advertisement.

18. A system, comprising:
a processor; and
a memory comprising program instructions executable by the processor to:
receive one or more keywords for searching one or more images on a network;
retrieve the images based on the keywords;
group the images into one or more categories based on a first description associated with each image;
select one or more advertisements based on the categories;
rank the advertisements based on a first visual content of the images and
a second visual content of the advertisements; and
display the advertisements based on the ranking.

19. The system of claim 18, wherein the first visual content is based on an image hashcode for each image and the second visual content is based on an ad hashcode for each advertisement.

20. The system of claim 18, wherein the advertisements are selected based on a second description associated with each advertisement.
